(19) United States
(12) Patent Application Publication
(10) Pub. No.: US 2003/0214180 A1
(43) Pub. Date: Nov. 20, 2003

(54) Hydraulic brake system for vehicles

(75) Inventor: Akihito Kusano, Aichi (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/437,970

(22) Filed: May 15, 2003

(30) Foreign Application Priority Data
May 15, 2002 (JP) 2002-139879

(51) Int. Cl. B60T 8/42

(52) U.S. Cl. 303/116.2; 303/115.1

(57) ABSTRACT

An improved hydraulic brake system for a vehicle is proposed which includes a hydraulic pressure supply unit for supplying hydraulic pressure from a pressure adjusting valve or an hydraulic pressure source to a pressure chamber of a master cylinder. In this type of brake system, when the hydraulic pressure supply unit is activated, the master piston of the master cylinder could retract to its original position, thus bringing the master pressure chamber into communication with the atmospheric reservoir. If this happens, the master cylinder pressure output will be lost completely. An inexpensive solution to this problem is proposed. A piston retraction restricting member is provided in a pressure chamber for applying pressure to the master piston. The member is adapted to move to a predetermined position under the pressure in the pressure chamber to engage and stop the master piston before the master piston retracts to a position where the master pressure chamber is brought into communication with the atmospheric reservoir through a hole.

### BACKGROUND OF THE INVENTION

This invention relates to an inexpensive hydraulic brake system for vehicles that permit antilock brake control and vehicle stability control.

A vehicle hydraulic brake system with which antilock brake control (ABS) and vehicle stability control (VSC) are possible includes a hydraulic pressure source having a power pump for generating a predetermined hydraulic pressure, a master cylinder for generating hydraulic pressure corresponding to a force applied to the brake by a driver and/or the operation of automatic pressurizing means, wheel cylinders actuated by the hydraulic pressure applied from the master cylinder for applying braking force to the vehicle wheels, and wheel cylinder pressure control valves disposed in hydraulic lines that connect the master cylinder to the wheel cylinders, for adjusting pressure in the wheel cylinders.

Also known is a brake system to which is further added a pressure adjusting valve for adjusting the hydraulic pressure supplied from the hydraulic pressure source to a value corresponding to the brake operation and/or actuation of the automatic pressurizing means.

These hydraulic brake devices include a controller (that is, electronic control unit) that judges the necessity of wheel cylinder pressure adjustment based on the information from various sensors including wheel speed sensors, and if such adjustment is determined to be necessary, controls the wheel cylinder pressure control valves. For example, if it judges it necessary to reduce the pressure of the wheel cylinders, the controller will activate the wheel cylinder pressure control valves to close the hydraulic pressure supply lines to the wheel cylinders and open the discharge lines from the wheel cylinders.

The pressures in the wheel cylinders thus fall. Brake fluid discharged from the wheel cylinders is released into the atmospheric reservoir. That is, during every pressure reduction phase of such electronic brake control, i.e. computer-controlled brake operation, brake fluid is discharged into the reservoir, so that the piston of the master cylinder (hereinafter simply “master piston”) gradually advances until it abuts the end wall of the cylinder. Once the master piston abuts the cylinder end wall, it is impossible to supply brake pressure any more from the master cylinder to the wheel cylinder.

The hydraulic brake system disclosed in Japanese patent publication 59-130769 has a hydraulic pressure supply means for introducing the pressure fluid from the pressure adjusting valve into the hydraulic line connecting the master cylinder with the wheel cylinders, if part of fluid in the above hydraulic line is lost and the amount of the fluid in this line is determined to be insufficient.

The hydraulic brake system disclosed in this publication includes a solenoid valve for closing the line connecting the hydraulic pressure supply means to the master cylinder, and/or a switch (stroke sensor) for monitoring the stroke of the master piston.

Once hydraulic pressure is supplied from a pressure adjusting valve into the hydraulic line connecting the master cylinder with the wheel cylinders, the difference between the pressure in a pressure chamber which is applied to the master piston in such a direction as to advance the piston and the pressure in the pressure chamber in the master cylinder (hereinafter “master pressure chamber”) will disappear, so that no pressure acts on the piston to retract it. Since the pressure difference is gone, unless any means for checking the retraction of the master piston is provided, the master cylinder would be pushed back under the force of the return spring to a position where the master pressure chamber communicates with the master cylinder reservoir. If this happens, the pressure output of the master cylinder will disappear.

Thus, the above publication proposes to close the line leading to the master cylinder with a solenoid valve to prevent the hydraulic pressure supplied through the hydraulic pressure supply means from flowing into the master hydraulic pressure chamber. In another embodiment, this publication proposes to detect the position of the master piston to temporarily stop the supply of brake fluid from the pressure adjusting valve before the master piston returns to a position where the master pressure chamber re-communicates with the reservoir for the master cylinder.

The hydraulic brake system disclosed in the Japanese patent publication 59-130769 needs expensive elements, such as a solenoid valve for closing the line between the master cylinder and the hydraulic pressure supply means and/or a sensor for monitoring the stroke of the master piston.

Another conventional brake system is adapted to release brake fluid discharged from the wheel cylinders into a low-pressure reservoir, draw up brake fluid in the low-pressure reservoir by means of a power pump and return the thus sucked up brake fluid into a line between the master cylinder and a master cylinder pressure control valve. This type of brake system requires another power pump for returning brake fluid in addition to a power pump used in the hydraulic pressure source. This pushes up the cost of the entire system.

An object of this invention is to provide an inexpensive hydraulic brake system for vehicles which permits antilock brake control, vehicle stability control and other electronic brake control.

### SUMMARY OF THE INVENTION

According to the invention, there is provided a vehicle hydraulic brake system comprising a hydraulic pressure source for generating a predetermined hydraulic pressure, a pressure adjusting valve for adjusting the hydraulic pressure supplied from the hydraulic pressure source to a value corresponding to a manual brake operation and/or an automatic brake control, a pressure chamber into which the output pressure from the pressure adjusting valve is introduced, a master cylinder including a master piston to which the hydraulic pressure in the pressure chamber is applied, wheel cylinders activated by the output pressure from the master cylinder to apply braking force to wheels of the vehicle, wheel cylinder pressure control valves provided in a hydraulic line connecting the master cylinder to the wheel cylinders for adjusting the hydraulic pressure in the wheel cylinders, and a hydraulic pressure supply unit for supplying the output pressure from the pressure chamber into a hydraulic line connecting the master cylinder to the wheel cylinder pressure control valves, characterized in that there is provided a piston retracting restricting member for preventing the master piston from retracting when the hydraulic pressure supply unit is activated and before the master piston returns to the original position.

According to the present invention, there is also provided a vehicle hydraulic brake system comprising a hydraulic pressure source for generating a predetermined hydraulic pressure, an atmospheric reservoir, control valves, a pressure chamber connected through the control valves to the hydraulic pressure source and the atmospheric reservoir, a master cylinder including a master piston to which the hydraulic pressure in the pressure chamber is applied, wheel cylinders activated by the output pressure from the master cylinder to apply braking force to wheels of the vehicle, wheel cylinder pressure control valves provided in a hydraulic line connecting the master cylinder to the wheel cylinders for adjusting the hydraulic pressure in the wheel cylinders, and a hydraulic pressure supply unit for supplying the output pressure from the pressure chamber into a hydraulic line connecting the master cylinder to the wheel cylinder pressure control valves, characterized in that there is provided a piston retracting restricting member for preventing the master piston from retracting when the hydraulic pressure supply unit is activated and before the master piston returns to the original position.

For economical reasons, said member is preferably actuated by the hydraulic pressure in the pressure chamber and is deactivated from its function of preventing the master piston from retracting when the pressure in the pressure chamber has been released.

Preferably, the member is adapted to prevent the master piston at a predetermined position, particularly at a slightly advanced position than a position where the hydraulic pressure chamber of the master cylinder is brought into communication with the atmospheric reservoir.

The master cylinder may be a tandem master cylinder comprising the master piston, a floating piston provided in front of the master piston, a first return spring provided between the master piston and the floating piston, a second return spring provided between the floating piston and an end wall of a cylinder of the master cylinder, and an assembly for restricting the expansion of the first return spring to a predetermined length, the first return spring having a larger mounting load than that of the second return spring.

When brake pressure is repeatedly increased and reduced during antilock brake control, vehicle stability control, etc., pressure in the line (first hydraulic line) connecting the master cylinder to the wheel cylinders gradually decreases. When the controller detects this situation, it activates the hydraulic pressure supply unit to open the line connecting the pressure chamber to the first hydraulic line, thereby supplying hydraulic pressure in the pressure chamber (fluid pressure from the pressure adjusting valve or the hydraulic pressure source) to the first hydraulic line.

When the pressure of the pressure chamber is supplied into the master pressure chamber, the master piston begins to retract. The piston retraction restricting member engages and stops the piston at a predetermined position. This member may be a simple tubular member. Still, it can reliably stop the retraction of the master piston before the master pressure chamber communicates with the atmospheric reservoir. This simple member eliminates the need for more expensive solenoid valves and stroke sensors as used in the prior art described above.

### BRIEF DESCRIPTION OF THE DRAWINGS

Other features and objects of the present invention will become apparent from the following description made with reference to the accompanying drawings, in which:

FIG. 1 is a view showing the entire hydraulic brake system according to this invention;

FIG. 2 is an enlarged sectional view of the hydraulic pressure adjusting device of the brake system of FIG. 1; and

FIG. 3 is a view of the hydraulic brake system of another embodiment.

### DETAILED DESCRIPTION OF THE PREFERRED EMBODIMENT

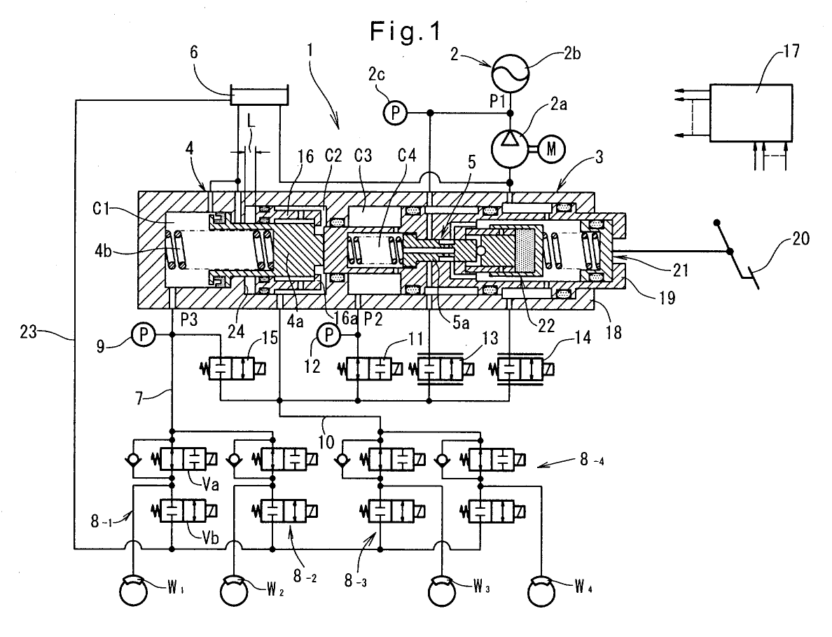

Now referring to FIGS. 1-3, the embodiments of this invention will be described.

The hydraulic brake system 1 shown in FIG. 1 includes a hydraulic pressure source 2 having a power pump 2a, a pressure accumulator 2b and a pressure sensor 2c; a hydraulic pressure adjusting unit 3 including a master cylinder 4 and a pressure adjusting valve 5; an atmospheric reservoir 6 for supplying brake fluid to the hydraulic pressure source 2 and the master cylinder 4, and wheel cylinders W₁-W₄ for applying braking force to the respective vehicle wheels. The brake system 1 further includes wheel cylinder pressure control valves 8₋₁ and 8₋₂ and a pressure sensor 9 disposed in a first hydraulic line 7 that connects the master cylinder 4 to the wheel cylinders W₁ and W₂, and wheel cylinder pressure control valves 8₋₃ and 8₋₄, a solenoid valve 11 and a pressure sensor 12 disposed in a second hydraulic line 10 connecting the pressure adjusting valve 5 to the wheel cylinders W₃ and W₄. The brake system 1 further includes two proportional solenoid valves 13 and 14 (which produce a differential pressure corresponding to an electronic command), a solenoid valve 15 disposed in a hydraulic line extending from a pressure chamber C2 to the first hydraulic line 7, a piston retraction restricting member 16 provided in the pressure chamber C2, a controller (electronic control unit) 17 for controlling the entire brake system 1, and various sensors (only pressure sensors shown) for detecting the behavior of the vehicle and the status of the drive train and sending detection signals to the controller 17. The proportional solenoid valve 13 is disposed in a hydraulic line connecting the delivery port of the pump 2a to the hydraulic line 10 not through the solenoid valve 11. The proportional solenoid valve 14 is disposed in a pressure-reducing hydraulic line connecting the atmospheric reservoir 16 to the hydraulic line 10 not through the solenoid valve 11.

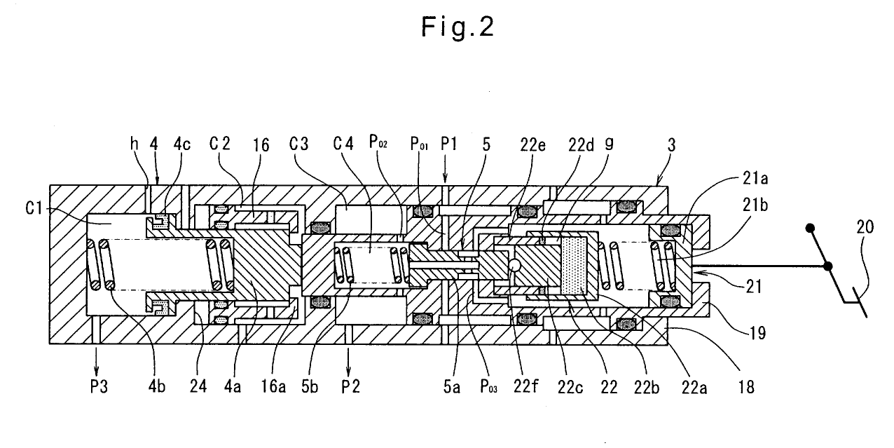

FIG. 2 is an enlarged view of the hydraulic pressure adjusting unit 3. It includes a cylinder 18, an auxiliary piston 19 mounted in the cylinder 18, a stroke simulator 21 comprising a simulator piston 21a operatively associated with a brake operating member 20 (such as a brake pedal shown) and a biasing member 21b that imparts to the simulator piston 21a a stroke corresponding to the brake operation, and a distributor 22 for distributing the brake operating force applied thereto to the pressure adjusting valve 5 and the auxiliary piston 19 through the stroke simulator 21.

The master cylinder 4 comprises a master piston 4a having its front surface disposed in a master hydraulic pressure chamber C1 and its rear surface disposed in the pressure chamber C2, a return spring 4b for the master piston 4a, and a seal 4c for sealing the outer periphery of the piston 4a.

The pressure adjusting valve 5 includes a spool 5a to change over the increase, decrease and keeping of the output pressure. The spool 5a is adapted to move to a position where the sum of a thrust force corresponding to the hydraulic pressure in a pressure chamber C4 and the force of the return spring 5b balances with the force transmitted from the brake operating member 20 to the spool 5a through the distributor 22. The auxiliary piston 19 is formed with an input port P₀₁, an output port P₀₂ and a pressure reduction port P₀₃. According to the position of the spool 5a, the output pressure at the output port P₀₂ can be increased, reduced or maintained. That is, according to the position of the spool 5a, the output port P₀₂ is selectively connected to the input port P₀₁ or pressure reduction port P₀₃ or to neither of them. While the input port P₀₁ is in communication with the output port P₀₂ through a passage in the spool 5a, the degree of opening of a valve portion defined between a shoulder of the spool 5a and the input port P₀₁ is adjusted by slight movement of the spool 5a. Similarly, while the output port P₀₂ is in communication with the pressure reduction port P₀₃ through the passage in the spool 5a, the degree of opening of a valve portion defined between a shoulder of the spool 5a and the pressure reduction port P₀₃ is adjusted by slight movement of the spool 5a. Thus, the hydraulic pressure P1 supplied from the hydraulic pressure source 2 is adjusted to a hydraulic pressure P2 corresponding to the force applied to the brake operating member 20 and the hydraulic pressure P2 is supplied to the wheel cylinders W₃ and W₄ through the fluid chambers C4 and C3. Since the pressure adjusting valve 5 is known in the art, its detailed description is omitted.

The force distributor 22 comprises a cup member 22a, a rubber disk 22b provided in the cup member 22a, a force transmission member 22c, a tubular member 22e having one end thereof supported by the auxiliary piston 19 and the other end carrying a resin ring 22d and inserted in the cup member 22a so as to oppose the rubber disk 22b with a gap g formed therebetween, and a steel ball 22f mounted to the force transmission member 22c so as to abut the spool 5a.

In the initial stage of brake operation, the force applied from the brake operating member 20 is transmitted only to the pressure adjusting valve 5 through the rubber disk 22b, transmission member 22c and steel ball 22f of the force distributor 22. When the brake operating force exceeds a threshold, the rubber disk 22b will be elastically deformed to fill the gap g, thus coming into contact with the resin ring 22d. Once the rubber disk 22b contacts the resin ring 22d, part of the brake operating force is transmitted to the auxiliary piston 19 through the tubular member 22e.

Since the brake operating force is transmitted only to the adjusting valve 5 in the initial stage of brake operation, it is possible to quickly increase the braking force, that is, to give jumping characteristics to the brake system. The inner diameter of the tubular member 22e and the outer diameter of the force transmission member 22c determine the ratio between the force transmitted to the pressure adjusting valve 5 and the force transmitted to the auxiliary piston 19. The lengths of these members determine the timing at which the distribution of the brake operating force starts. Thus, one or both of these parameters can be changed by replacing the tubular member 22e and the force transmission member 22c with ones having different diameters and/or different lengths.

In this regard, the force distributor 22 is a preferable element. But it may be omitted. If omitted, the brake operating force is directly transmitted to the pressure adjusting valve 5.

The auxiliary piston 19 is provided to directly transmit the brake operating force to the master piston 4a in case the hydraulic pressure source 2 or a line connecting thereto fails. The hydraulic pressure output from the pressure adjusting valve 5 is introduced into the pressure chamber C2 to push the auxiliary piston 19 rightwardly in the figure and keep it in the illustrated position. However, if the hydraulic pressure source 2 fails and no pressure is produced in the pressure chamber C2, the auxiliary piston 19 will be pushed leftwardly by the force transmitted from the brake operating member 20 through the force distributor 19, thus applying pressure to the master piston 4a. The hydraulic pressure thus produced in the master cylinder 4 is used to produce the braking force. Thus, even if the hydraulic pressure source 2 fails, it is still possible to apply brake.

The solenoid valve 11 and the proportional solenoid valves 13, 14 in FIG. 1 are provided to allow regenerative cooperative braking control and automatic brake control (such as vehicle stability control or car-to-car distance control), which does not depend on brake operation of a driver.

In regenerative cooperative brake control used in an electric vehicle, priority is given to regenerative braking. This means that while regenerative braking is on, it is necessary to reduce the braking force originating from hydraulic pressure by an amount corresponding to the regenerative braking force set for the wheels.

The controller 17 calculates the optimum regenerative braking force to be generated based on information from elements involved in regenerative braking, such as sensors, and controls the solenoid valve 11 and the proportional solenoid valves 13 and 14 so that the difference between the hydraulic pressure P2 in the fluid chamber C3, which is detected by the pressure sensor 12, and the hydraulic pressure P3 in the master hydraulic pressure chamber C1, which is detected by the pressure sensor 9, will be equal to the pressure corresponding to the calculated regenerative braking force.

With this arrangement, reduced hydraulic pressure is supplied to the wheel cylinders W₃ and W₄. Also, since due to this pressure reduction, the hydraulic pressure in the pressure chamber C2 also drops, the hydraulic pressure output of the master cylinder 4 will also drop, so that the braking force applied to the wheels by the wheel cylinders W₁-W₄ also drops by an amount corresponding to the regenerative braking force.

Even during such regenerative cooperative brake control, the auxiliary piston 19 is biased rightwardly in FIG. 2 by the hydraulic pressure in the fluid chamber C3. Thus, provided the hydraulic pressure source 2 is functioning normally, the piston 19 remains stationary at the position shown in FIG. 1 even during regenerative cooperative brake control.

The proportional solenoid valve 13 permits automatic brake control, i.e. brake control with the brake not operated by the driver. In such automatic brake control, the controller 17 closes the solenoid valve 11 and opens the proportional solenoid valve 13 to apply hydraulic pressure output of the hydraulic pressure source 2 to the wheel cylinders W₃ and W₄. The hydraulic pressure also flows into the pressure chamber C2, so that the master cylinder 4 is also pressurized. This activates the wheel cylinders W₁ and W₂ which give braking force to the wheels.

Each of the wheel cylinder pressure control valves 8₋₁ to 8₋₄ shown comprises a solenoid valve Va having a check valve and adapted to open and close the line leading to the wheel cylinder, and a solenoid valve Vb for opening and closing the discharge line from the wheel cylinder. But instead of the valves Va and Vb, a single solenoid changeover valve having both functions may be used.

Brake fluid discharged from each wheel cylinder through the solenoid valve Vb flows through a discharge line 23 back to the atmospheric reservoir 6.

Thus, during antilock brake control, vehicle stability control, and other brake control which involve repeated pressure increase and reduction, the volume of the master hydraulic pressure chamber C1 tends to decrease gradually. This means that the master piston 4a gradually advances and will eventually abut the end wall of the cylinder 18, unless any preventive measures are taken. Once the master piston 4a abuts the end wall of the cylinder 18, no hydraulic pressure can be supplied from the master cylinder 4 any more.

In order to prevent the master piston 4a from abutting the end wall of the cylinder 18, the hydraulic brake system 1 of FIG. 1 has a hydraulic pressure supply means (solenoid valve 15) for supplying, when necessary, hydraulic pressure of the pressure chamber C2 (hydraulic pressure output of the pressure adjusting valve 5 or hydraulic pressure source 2) to the hydraulic pressure line 7.

When the solenoid valve 15 is opened, the fluid pressure in the pressure chamber C2 is supplied to the fluid line 7 and the pressure chamber C2 and the master hydraulic pressure chamber C1 communicate with each other through the line 7. Thus, the difference between the pressure in the master hydraulic chamber C1 and the pressure in the pressure chamber C2, which act on both ends of the master piston 4a to bias the master piston in opposite directions, disappears. The master piston 4a is thus pushed back by the force of the return spring 4b.

If the master piston 4a were allowed to retract to the original position shown in FIG. 1, the master hydraulic pressure chamber C1 would be brought into communication with the atmospheric reservoir 6 through a hole h formed in the cylinder 18, resulting in the loss of hydraulic pressure in the master hydraulic pressure chamber C1. Of course, this must not happen because brake control is now being carried out. The present invention proposes an inexpensive solution to this problem, which comprises a piston retraction restricting member 16.

The piston retraction restricting member 16 is a tubular piston mounted between the outer periphery of the master piston 4a and the inner surface of the pressure chamber C2. It is movable under the pressure in the pressure chamber C2 until it abuts the end wall 24 of the atmospheric chamber.

While the solenoid valve 15 is open and the pressure difference between the master hydraulic pressure chamber C1 and the pressure chamber C2 is zero, the piston retraction restricting member 16 is kept in abutment with the end wall 24 to restrict the retraction of the master piston 4a. The member 16 has a stopper 16a adapted to engage the shoulder of the master piston 4a to perform its function. The master piston 4a and the member 16 are arranged such that when, with the member 16 in abutment with the end wall 24, the master piston 4a has moved rightwardly in FIG. 1 by the return spring 4b to a position displaced leftwardly from its original position of FIG. 1 by a distance L, the shoulder of the master piston 4a is engaged by the stopper 16a of the member 16. In this state, the master hydraulic pressure chamber C1 will never open to the atmospheric reservoir 6 through the hole h.

When the brake pedal is released or when computer-initiated brake control ends, so that the pressure in the pressure chamber C2 disappears, the master piston 4a will be pushed back to the original position shown in FIG. 1 together with the member 16 under the force of the return spring 4b.

In order to minimize the stroke L of the member 16 and thus the entire length of the brake system, the master piston 4a and the retraction restricting member 16 are preferably arranged such that the master piston 4a will be stopped by the member 16 immediately before a point where the master hydraulic pressure chamber C1 is brought into communication with the atmospheric reservoir 6.

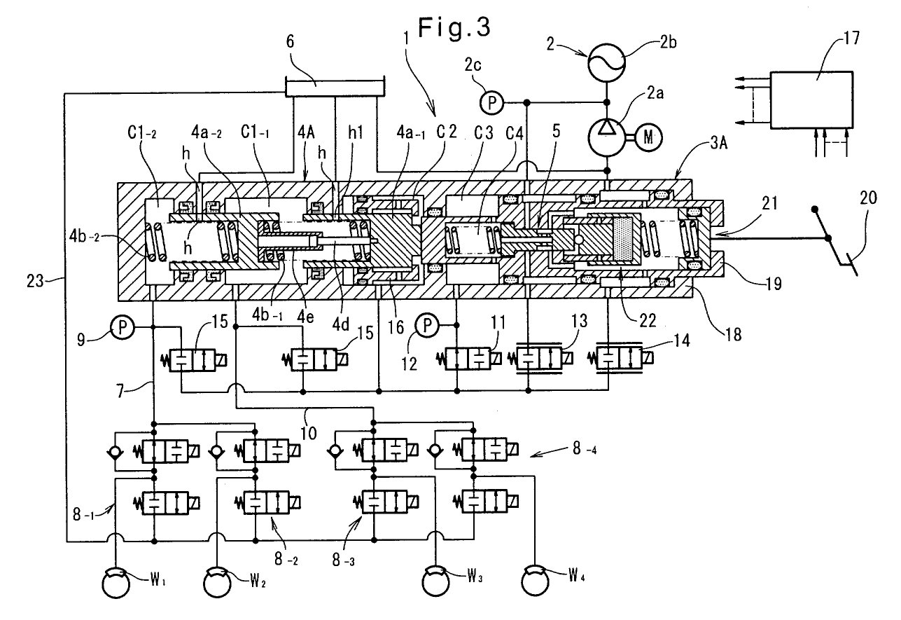

FIG. 3 shows a hydraulic brake system of the second embodiment. This brake system includes a hydraulic pressure adjusting device 3A having a tandem master cylinder.

The tandem master cylinder 4A includes a master piston 4a₋₁ having one end thereof disposed in a first master hydraulic pressure chamber C1₋₁ and the other end disposed in the pressure chamber C2, a floating piston 4a₋₂ (which is another master piston) having one end thereof disposed in a second master hydraulic pressure chamber C1₋₂ and the other end disposed in the first master hydraulic pressure chamber C1₋₁ and provided in front of the master piston 4a, a first return spring 4b₋₁ provided between the master piston 4a₋₁ and the floating piston 4a₋₂, and a second return spring 4b₋₂ provided between the floating piston 4a₋₂ and the end wall of the cylinder 18.

A support pin 4d is fixed to the master piston 4a₋₁ so as to extend toward the floating piston 4a₋₂. A retainer 4e is slidably fitted on the support pin 4d, which has a large-diameter free end which serves to engage the free end of the retainer 4e, thereby keeping the retainer 4e from coming off the pin 4d. The retainer 4e has its other end in abutment with the floating piston 4a₋₂. One end of the first return spring 4b₋₁ is mounted on the retainer 4e. Thus, the spring 4b₋₁ cannot expand beyond the point at which the large-diameter end of the pin 4d is in engagement with the free end of the retainer 4e.

Also, the mounting load for the first return spring 4b₋₁ is set to be larger than the mounting load for the second return spring 4b₋₂.

In the pressure chamber C2, a piston retraction restricting member 16 which is the same as the one shown in FIG. 1 is provided. In the hydraulic brake system of FIG. 3 the hydraulic pressure produced in the first master pressure chamber C1₋₁ of the tandem master cylinder 4A is applied to the wheel cylinders W₃ and W₄ through the second hydraulic line 10 and the hydraulic pressure produced in the second master pressure chamber C1₋₂ is applied to the wheel cylinders W₁ and W₂ through the first hydraulic line 7. Thus, during antilock brake control, vehicle stability control, and other brake control which involve repeated pressure increase and pressure reduction, the master piston 4a₋₁ and the floating piston 4a₋₂ will gradually advance, so that the master pressure chambers C1₋₁ and C1₋₂ may be brought into communication with the atmospheric reservoir 6 through holes h1 formed in the master piston 4a₋₁ and the floating piston 4a₋₂ and holes h formed in the cylinder 18. If this should happen, it becomes impossible to supply fluid pressure to either of the first and second hydraulic lines. To prevent such a failure, solenoid valves 15 for supplying hydraulic pressure are provided in the first and second hydraulic lines.

Otherwise, the second embodiment is structurally the same as the first embodiment. Thus, like elements are denoted by like numerals and description is omitted.

When the pressure output from the pressure chamber C2 is supplied through the solenoid valves 15 into the hydraulic lines 7 and 10, the piston retraction restriction member 16 engages the master piston 4a₋₁, thereby preventing it from moving rightwardly any further. In this state, the mounting load of the first return spring 4b₋₁, which biases the floating piston 4a₋₂ leftwardly in FIG. 3, is set to be greater than that of the second return spring 4b₋₁, which biases the floating spring 4b₋₁ rightwardly in FIG. 3. Thus, the first return spring 4b₋₁ is not compressed by the second return spring 4b₋₂. This means that the floating piston 4a₋₂, too, remains stationary at this position. Thus, it is possible to maintain the hydraulic pressures both in the first and second master pressure chambers C1₋₁ and C1₋₂.

In the description of the embodiments, pressure fluid is supplied from the pressure chamber C3 into the master pressure chamber or chambers. But instead, pressure fluid may be directly supplied from the pressure source 2 to the hydraulic pressure line at the master cylinder side by opening the valves 13 and 15 while closing the valve 11. In the latter case, the pressure adjusting valve 5 is not necessary.

The piston retraction restricting member as described above eliminates the necessity of providing more expensive conventional elements, such as a solenoid valve for closing the line between the hydraulic pressure supply means and the master cylinder, and a stroke sensor for detecting the position of the master piston. This reduces the entire cost of the brake system.

What is claimed is:

1. A vehicle hydraulic brake system comprising a hydraulic pressure source for generating a predetermined hydraulic pressure, a pressure adjusting valve for adjusting the hydraulic pressure supplied from said hydraulic pressure source to a value corresponding to a manual brake operation and/or an automatic brake control, a pressure chamber into which the output pressure from said pressure adjusting valve is introduced, a master cylinder including a master piston to which the hydraulic pressure in said pressure chamber is applied, wheel cylinders activated by the output pressure from said master cylinder to apply braking force to wheels of the vehicle, wheel cylinder pressure control valves provided in a hydraulic line connecting said master cylinder to said wheel cylinders for adjusting the hydraulic pressure in said wheel cylinders, and a hydraulic pressure supply unit for supplying the output pressure from said pressure chamber into a hydraulic line connecting said master cylinder to said wheel cylinder pressure control valves, characterized in that there is provided a piston retraction restricting member for preventing said master piston from retracting when said hydraulic pressure supply unit is activated and before said master piston returns to the original position.

2. A vehicle hydraulic brake system comprising a hydraulic pressure source for generating a predetermined hydraulic pressure, an atmospheric reservoir, control valves, a pressure chamber connected through said control valves to said hydraulic pressure source and said atmospheric reservoir, a master cylinder including a master piston to which the hydraulic pressure in said pressure chamber is applied, wheel cylinders activated by the output pressure from said master cylinder to apply braking force to wheels of the vehicle, wheel cylinder pressure control valves provided in a hydraulic line connecting said master cylinder to said wheel cylinders for adjusting the hydraulic pressure in said wheel cylinders, and a hydraulic pressure supply unit for supplying the output pressure from said pressure chamber into a hydraulic line connecting said master cylinder to said wheel cylinder pressure control valves, characterized in that there is provided a piston retracting restricting member for preventing said master piston from retracting when said hydraulic pressure supply unit is activated and before said master piston returns to the original position.

3. The hydraulic brake system claimed in claim 1 or 2 wherein said piston retraction restricting member is actuated by the hydraulic pressure in said pressure chamber and is deactivated from its function of preventing said master piston from retracting when the pressure in said pressure chamber has been released.

4. The hydraulic brake system claimed in any of claims 1-3 wherein said piston retraction restricting member prevents said master piston at a predetermined position.

5. The hydraulic brake system claimed in claim 4 wherein said predetermined position is a slightly advanced position than is a position where the hydraulic pressure chamber of said master cylinder is brought into communication with said atmospheric reservoir.

6. The hydraulic brake system claimed in any of claims 1-5 wherein said master cylinder is a tandem master cylinder comprising said master piston, a floating piston provided in front of said master piston, a first return spring provided between said master piston and said floating piston, a second return spring provided between said floating piston and an end wall of a cylinder of said master cylinder, and an assembly for restricting the expansion of said first return spring to a predetermined length, said first return spring having a larger mounting load than that of said second return spring.
